(19) United States
(12) Patent Application Publication
(10) Pub. No.: US 2014/0122774 A1
(43) Pub. Date: May 1, 2014

(54) Method for Managing Data of Solid State Storage with Data Attributes

(71) Applicant: Hong Kong Applied Science and Technology Research Institute Company Limited, (US)

(72) Inventors: Shuguang Xian, Hong Kong (HK); Zhan Wang, Hong Khong (HK); Banghong Chen, Hong Kong (HK); Shuihua Hu, Hong Kong (HK); Yu Song, Hong Kong (HK)

(73) Assignee: Hong Kong Applied Science and Technology Research Institute Company Limited, Hong Kong (HK)

(21) Appl. No.: 13/664,417

(22) Filed: Oct. 31, 2012

(51) Int. Cl. G06F 12/02

(52) U.S. Cl. 711/103; 711/E12.008; 711/E12.009

(57) ABSTRACT

Different FTL implementations, including the use of different mapping schemes, log block utilization, merging, and garbage collection strategies, perform more optimally than others for different data operations with certain characteristics. The presently claimed invention provides a method to distinguish and categorize the different data operations according to their different characteristics, or data attributes; then deploy the most optimal mapping schemes, log block utilization, merging, and garbage collection strategies depending on the data attributes; wherein the data attributes include, but are not limited to, access frequency, access sequence, access size, request mode, and request write ratio.

### FIELD OF THE INVENTION

The present invention relates generally to electronic memory storage devices, and more specifically to NAND flash memory devices. More specifically, the present invention relates to the persistent data storage in and retrieval from solid state disks based on NAND flash memory devices.

### BACKGROUND

Flash memory is a type of non-volatile electronic data storage circuitry that can be electronically programmed to hold data and be erased repeatedly, thus well suitable as a rewritable data storage medium used in electronics and computer systems. NAND flash memory is a special type of flash memory that uses floating-gate transistors connected serially in a NAND gate fashion. The NAND flash memory technology is widely used in computer systems, digital cameras, portable music players, USB flash drives, memory cards, and SmartMedia™ cards. Particularly in computer systems and persistent data storage systems, it is increasingly common that magnetic disk-based data storage media are being replaced by solid state disks that utilize NAND flash memories as these solid state disks maintain certain advantages over magnetic disk-based data storage media in that they have less power consumption, better physical shock resistance and electromagnetic compatibility characteristics, smaller physical size, and lower weight.

NAND flash memories come in different capacities and electronic architectures depending on the manufacture, model, and technology used. For example, memory banks in a NAND flash memory device are arranged into blocks with sizes including but not limited to 16K, 128K, 256K, or 512K bytes. Each block is further organized into pages. The number of pages can be 32, 64, 128, or more with each page having a possible size of 256, 512, 1K, 2K, 4K, or 8K bytes. Other technical variations arise in other attributes such as block type, address cycles, and size of spare memory space.

In general the data storage operations of NAND flash memories comprise three basic operations: page read, page program (or equivalent to write), and block erase. Before a page can be programmed or re-programmed, a block erase of the block containing the page must be performed first. The speeds of the operations are asymmetrical. A page read is much faster than a page program or block erase. In addition, memory cells of NAND flash memories have limited lifespan. A memory cell will wear out after certain number of erase-cycles. Typically, a single-level-cell (SLC) has a life of 100,000 erase-cycles, and a multi-level-cell (MLC) has a life of 3,000 to 10,000 erase-cycles. Thus, various data storage operation schemes have been developed to minimize the block erase operations and spread the block erase operations evenly to all blocks.

Because of the abovementioned data storage operation characteristics, a string of data might be stored in physical memory locations in a NAND-flash-based solid state disk that do not correspond to the logical order of the data bits in the string of data. As such, a mapping scheme is needed for mapping the logical memory addresses of the data to the physical memory addresses in a NAND-flash-based solid state disk.

In general, the software and hardware architectures of a NAND-flash-based solid state disk comprise a host interface, a cache buffer, a flash translation layer (FTL), a NAND flash controller (NFC) driver, and a NAND flash array. The FTL is responsible for translating the logical addresses of data to and from the physical memory addresses of where the data are or will be stored in the NAND flash array. There are three types of mapping schemes corresponding to the different degrees of mapping granularity. They are block mapping, page mapping, and hybrid mapping. The block mapping scheme maps the logical addresses to physical addresses at the block level. It provides a small mapping table but the disadvantage is that it causes excessive copying of data of valid pages, resulting in poor random write performance and short lifespan of the memory cells. The page mapping scheme maps the logical addresses to physical addresses at the page level. This requires large mapping table, which creates significant hardware resource challenges. The complicated garbage collection also degrades response time performance of the solid state disk. The hybrid mapping scheme incorporates certain features from both the block mapping and page mapping schemes to achieve an optimal solution.

Besides translating the logical addresses of data to and from the physical memory addresses of where the data are or will be stored in the NAND flash array, the FTL is also generally responsible for bad block management, garbage collection, and wear leveling. For bad block management, a bad block is identified, isolated, and replaced by a spare block, wherein the bad block is generated during manufacturing or the lifetime of the memory. For garbage collection, a block that contains invalid pages (pages that contain outdated data) is to be garbage-collected or block-erased. The garbage collection first copies the valid pages in the garbage block to another block before commencing the block erase on the garbage block. For wear leveling, page program and block erase operations are managed such that they are performed over all blocks evenly in frequency over a period of time.

Various FTL implementations have been proposed and deployed. One such implementation is the Basic Associative Sector Translations (BAST). Details of the BAST is disclosed in the paper: Jesung Kim et al., “A Space-Efficient Flash Translation Layer for CompactFlash Systems”, IEEE Transaction on Consumer Electronics, Volume 48, No. 2, May 2002; the content of which is incorporated herein by reference in its entirety. BAST is a log block based FTL that uses a hybrid mapping in which one dedicated log block is associated with one data block. When a page program operation for writing new data to a data block is commanded, the new data is programmed (written) in a free page in the associating log block first. As such, only a small page mapping table for the log blocks is needed. However, the utilization of the log blocks are low; and during heavy random write workload, the free blocks can be used up very fast, in turn triggering many expensive block merging and garbage collection operations. Such a phenomenon where most page program (write) requests invoke a block merge is called log block thrashing. A block merging operation means all the valid pages, which contain the up-to-date data, from the log block and the associating data block are to be merged back to the data block, such that the data block has all valid pages containing the up-to-date data.

Another FTL implementation is the Fully Associative Sector Translations (FAST). Details of the FAST is disclosed in the paper: Sang-Won Lee et al., “A Log Buffer-based Flash Translation Layer using Fully-associative Sector Translation”, ACM Transactions on Embedded Computing Systems (TECS), Volume 6 Issue 3, July 2007; the content of which is incorporated herein by reference in its entirety. FAST is a log block based FTL that uses a hybrid mapping in which one log block is shared by all data blocks. When a page program operation for writing new data to a data block is commanded, the new data is first programmed (written) in an free page in the currently used log block. Under this implementation, the utilization of log blocks is improved over BAST. The block merging operations can be deferred during heavy random write workload. However, because the association of one log block to multiple data blocks is high, the merging operations are complicated and have low efficiencies. The time needed for a merging operation under the worst-case scenario is exceedingly long, and merging operations might be needed frequently (log block thrashing problem).

Still another FTL implementation is the Set Associative Sector Translations (SAST). Details of the SAST is disclosed in the paper: Chanik Park et al., “A Reconfigurable FTL (Flash Translation Layer) Architecture for NAND Flash based Applications”, Proceedings of the 18^{th} IEEE/IFIP International Workshop on Rapid System Prototyping, pages 202-8, May 2007; the content of which is incorporated herein by reference in its entirety. Under this implementation, each group of K number of log blocks is associated with a group of N number of sequential data blocks. Although the numbers K and N can be statically adjusted to achieve the optimal performance for particular data storage/retrieval application behavior and workload, these numbers are difficult to define. Log block thrashing is also a problem under SAST.

The K-Associative Sector Translation (KAST) is a variant of SAST in which N is equal to one. Details of the KAST is disclosed in the U.S. Patent Application Publication 2010/0169544 entitled: “Methods for Distributing Log Block Associativity for Real-time System and Flash Memory Devices Performing the Same”; the content of which is incorporated herein by reference in its entirety. Under KAST, similar disadvantages as those of SAST exist. In addition, the utilization rate of log blocks is lower.

The Hybrid Flash Translation Layer (HFTL) combines the BAST and FAST implementations. Details of the HFTL is disclosed in the paper: Hak Soo Kim et al., “Hybrid Log Block Buffer Scheme in a Flash Translation Layer”, IAIT, 2007; the content of which is incorporated herein by reference in its entirety. Under the HFTL, data blocks are identified and divided into hot and cold data blocks where hot data blocks are subjected to heavy sequential page program (write) operations (hot data) while cold data blocks are not (cold data). Hot data blocks are each associated with a dedicated log block, following the BAST approach. All cold data blocks share the same log block, following the FAST approach. The HFTL has the advantages of having fewer block erase operations, better log block utilization rate, and higher efficiency in garbage collection. Nonetheless, log block thrashing problem continues to exist.

### SUMMARY

It is an objective of the presently claimed invention to provide a method for managing data of solid state storage by implementing an intelligent FTL that recognizes the different characteristics of data operations and be able to actively adjust its task execution and strategies accordingly.

Different FTL implementations, including the use of different mapping schemes, log block utilization, merging, and garbage collection strategies, perform more optimally than others for different data operations with certain characteristics. It is a further objective of the presently claimed invention to distinguish and categorize the different data operations according to their different characteristics, or data attributes. The presently claimed invention then provides a method to deploy the most optimal mapping schemes, log block utilization, merging, and garbage collection strategies depending on the data attributes; wherein the data attributes include, but are not limited to, access frequency, access sequence, access size, request mode, and request write ratio.

In accordance to various embodiments, an attribute-aware FTL maintains a data attribute table in which data attribute values of a workload of data write and/or read accesses and/or requests are recorded. The data attribute values are binary values. In one embodiment, the data for the solid state drive is divided into segments by logical addresses (or logical zone) and separate set of the abovementioned five data attribute values is calculated for each logical zone. The calculation of the five data attribute values is based on the statistics of prior data write and/or read accesses and/or requests (input/output) during a pre-defined time slice.

In accordance to one embodiment, the attribute-aware FTL inquires the data attribute table for every data write request to determine the best mapping scheme, log block utilization, merging, and garbage collection strategy for the data write request. In accordance to another embodiment, the data caching strategy of a solid state drive is adjustable based on data attributes.

### BRIEF DESCRIPTION OF THE DRAWINGS

Embodiments of the invention are described in more detail hereinafter with reference to the drawings, in which

FIG. 1 shows an exemplary embodiment of a data attribute table maintained by an attribute-aware FTL in which data attribute values of a workload of data write and/or read accesses and/or requests are recorded;

FIG. 2 shows a process flow diagram illustrating the execution steps of an attribute-aware FTL using the data attribute values of a workload of data write and/or read accesses and/or requests in selecting a mapping scheme, log block utilization, merging, and garbage collection strategy;

FIG. 3 shows a process flow diagram illustrating the execution steps of an attribute-aware data cache using the data attribute values of a workload of data write and/or read accesses and/or requests in selecting a data caching strategy; and

FIG. 4 shows a process flow diagram illustrating the execution steps of a solid state disk with attribute-aware FTL and attribute-aware data cache.

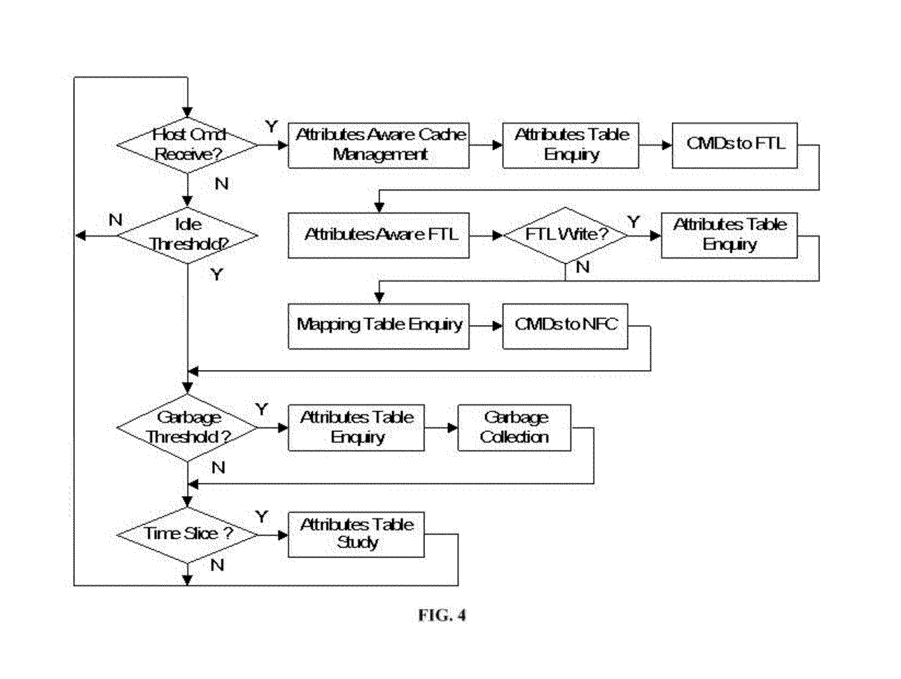

### DETAILED DESCRIPTION

In the following description, systems and methods of managing data of solid state storage according to data attributes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Different FTL implementations, including the use of different mapping schemes, log block utilization, merging, and garbage collection strategies, perform more optimally than others for different data operations with certain characteristics. The presently claimed invention provides an attribute-aware FTL that can distinguish and categorize the different data operations according to their different characteristics, or data attributes. The attribute-aware FTL deploys the most optimal mapping schemes, log block utilization, merging, and garbage collection strategies depending on the data attributes; wherein the data attributes include, but are not limited to, access frequency, access sequence, access size, request mode, and request write ratio.

Access frequency indicates whether the data is hot data or cold data by defining an access frequency threshold above which the data is hot data, otherwise cold data. To optimize performance, hot data should be organized with page mapping schemes and cold data with block mapping schemes. As such, the attribute-aware FTL preserves certain number of the log blocks and dedicate them to a hot log block zone for hot data, and other blocks to a cold log block zone for cold data.

By analyzing the statistics based on the logical data addresses of the data accesses (write and/or read) to the solid state drive, it can be predicted whether the data accesses are sequential or random. Knowing this information can influence the mapping scheme selection. For instance, a series of sequential data accesses is best handled by a block mapping scheme with the starting logical address mapped to the beginning of one log block—the first page of that log block.

For large size data accesses, such as those of larger than 64 KB, a block mapping scheme is more efficient than a page mapping scheme. Data requests to the solid state drive can be in burst or smooth fashion. For burst mode write requests, more log blocks should be reserved, the garbage collection operations should be triggered at a lower threshold. To optimize wear leveling, data requests with a majority number being write requests (high write ratio), block swapping should be performed with younger blocks; whereas a high read ratio (low write ratio) should impose block swapping with older blocks.

Typically, a plurality of data write and/or read accesses and/or requests in a workload unit would exhibit similar data access and/or request characteristics. As such, certain data attribute values can be assigned to each workload according to their access and/or request characteristics. However, data access and/or request characteristics of one workload can change overtime, thus its data attribute values should be reassessed from time to time.

In accordance to one embodiment of the presently claimed invention, a workload of data write and/or read accesses and/or requests can be characterized by one of the following access data attribute value combinations (or access workload types):
A1.) hot data, sequential access, and large size data accesses
A2.) hot data, sequential access, and small size data accesses
A3.) hot data, random access, and large size data accesses
A4.) hot data, random access, and small size data accesses
A5.) cold data, sequential access, and large size data accesses
A6.) cold data, sequential access, and small size data accesses
A7.) cold data, random access, and large size data accesses
A8.) cold data, random access, and small size data accesses

In accordance to another embodiment of the presently claimed invention, a workload of data write and/or read accesses and/or requests can further be characterized by one of the following request data attribute value combinations (or request workload types):
R1.) burst mode and high write ratio
R2.) burst mode and low write ratio
R3.) smooth mode and high write ratio
R4.) smooth mode and low write ratio

In accordance to various embodiments, an attribute-aware FTL maintains a data attribute table in which data attribute values of a workload of data write and/or read accesses and/or requests are recorded. The data attribute values are binary values. The first attribute is for indicating hot or cold data with the value ‘1’ being hot data. In one embodiment, hot data means the data within a particular logical address range is being accessed for 80% or more of the time in a workload during a particular time period. The second attribute is for indicating sequential or random access with the value ‘1’ being sequential. The third attribute is for indicating large or small size data access with the value ‘1’ being large size. In one embodiment, a large size data access means that of larger than 64 KB. The forth attribute is for indicating burst or smooth mode data request with the value ‘1’ being burst mode. The fifth forth attribute is for indicating high or low write ratio with the value ‘1’ being high write ratio. The first and the second attributes play a more important role influencing the selection of mapping scheme and log block usages.

In one embodiment, the data for the solid state drive is divided into segments by ranges of logical addresses (or logical zone). One set of the abovementioned five data attribute values is calculated for each logical zone. The computation of the five data attribute values is based on the statistics of prior data write and/or read accesses and/or requests (input/output) during a pre-defined time slice; therefore, each set of five data attribute values is recorded with a timestamp.

During run-time, the statistics collection and data attribute values calculation are executed as a background task of the attribute-aware FTL in order to avoid any degradation of response time of the solid state drive. The data attribute values are updated according to a pre-defined schedule at the end of the pre-defined time slice. The attribute-aware FTL makes inquiry to the data attribute table before selecting mapping scheme and a physical address for a page program operation (data write). The data attribute table is also inquired first prior to selecting the garbage collection strategy.

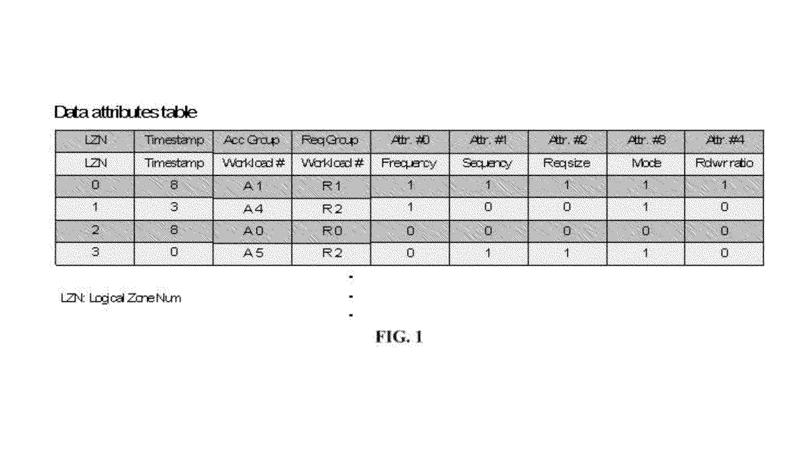

FIG. 1 shows an exemplary embodiment of the data attribute table in which data attribute values of a workload of data write and/or read accesses and/or requests are recorded. This exemplary data attribute table shows a snapshot of data attribute values calculated from statistics collected over a time slice during run-time. It shows that the solid state drive is divided into four logical zones: ‘0’, ‘1’, ‘2’, and ‘3’. There is a calculation and recording of data attribute values for logical zone ‘0’ data at time ‘8’; a calculation and recording of data attribute values for logical zone ‘1’ data at time ‘3’; a calculation and recording of data attribute values for logical zone ‘2’ data at time ‘8’; and a calculation and recording of data attribute values for logical zone ‘3’ data at time ‘3’.

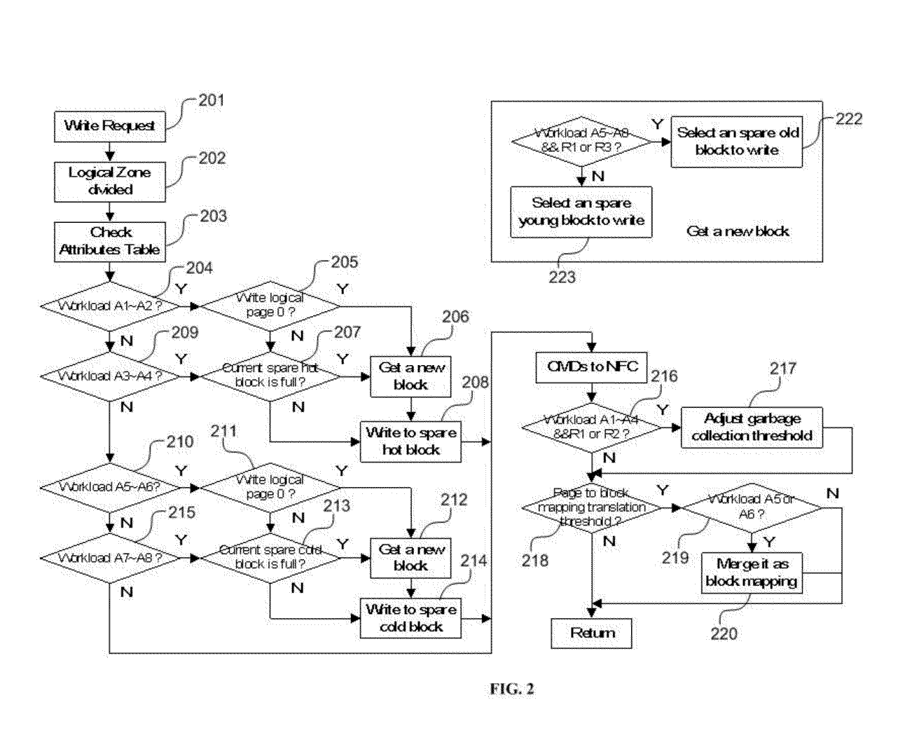

Referring to FIG. 2. In accordance to one embodiment of the presently claimed invention, an attribute-aware FTL uses the data attribute values of a workload of data write and/or read accesses and/or requests (or workload types) in selecting a mapping scheme, log block utilization, merging, and garbage collection strategy. The attribute-aware FTL execution steps start by receiving a data write request in step 201. The logical address of the data write request is used to determine the logical zone of the data write request in step 202. Inquiry to the data attribute table is made in step 203 to retrieve the data attributes for the data write request. If the data attributes indicate an A1 or A2 workload type (204), determine whether the data should be written to the first logical page (logical page 0) of a block (i.e. for large size data) in step 205; and if so a new block in the hot data zone is allocated for the data write request (206), otherwise check if the current spare block in the hot data zone is full in step 207. If the current spare block in the hot data zone is full, a new block in the hot data zone is allocated for the data write request (206), otherwise the current spare block in the hot data zone is used (208). If the data attributes indicate an A3 or A4 workload type (209), check if the current spare block in the hot data zone is full in step 207. If the current spare block in the hot data zone is full, a new block in the hot data zone is allocated for the data write request (206), otherwise the current spare block in the hot data zone is used (208). If the data attributes indicate an A5 or A6 workload type (210), determine whether the data should be written to the first logical page (logical page 0) of a block (i.e. for large size data) in step 211; and if so a new block in the cold data zone is allocated for the data write request (212), otherwise check if the current spare block in the cold data zone is full in step 213. If the current spare block in the cold data zone is full, a new block in the cold data zone is allocated for the data write request (212), otherwise the current spare block in the cold data zone is used (214). If the data attributes indicate an A7 or A8 workload type (215), check if the current spare block in the cold data zone is full in step 213. If the current spare block in the cold data zone is full, a new block in the cold data zone is allocated for the data write request (212), otherwise the current spare block in the cold data zone is used (214). After data is written in the solid state drive, the attribute-aware FTL commands the NAND flash controller (215): for workload type A1, A2, A3, or A4, and R1 or R2 (216), adjusts the garbage collection threshold in step 217, otherwise bypass step 217; then check whether the threshold for switching from page mapping scheme to block mapping scheme has been reached (218). If the threshold for switching from page mapping scheme to block mapping scheme has been reached and if the workload type is A5 or A6 (219), a merge using block mapping is commanded (220). For steps 206 and 212, for the workload type A5, A6, A7, or A8, and R1 or R3, an older (higher wear level) spare block is selected for the data write request (222); otherwise, a younger (lower wear level) spare block is selected (223).

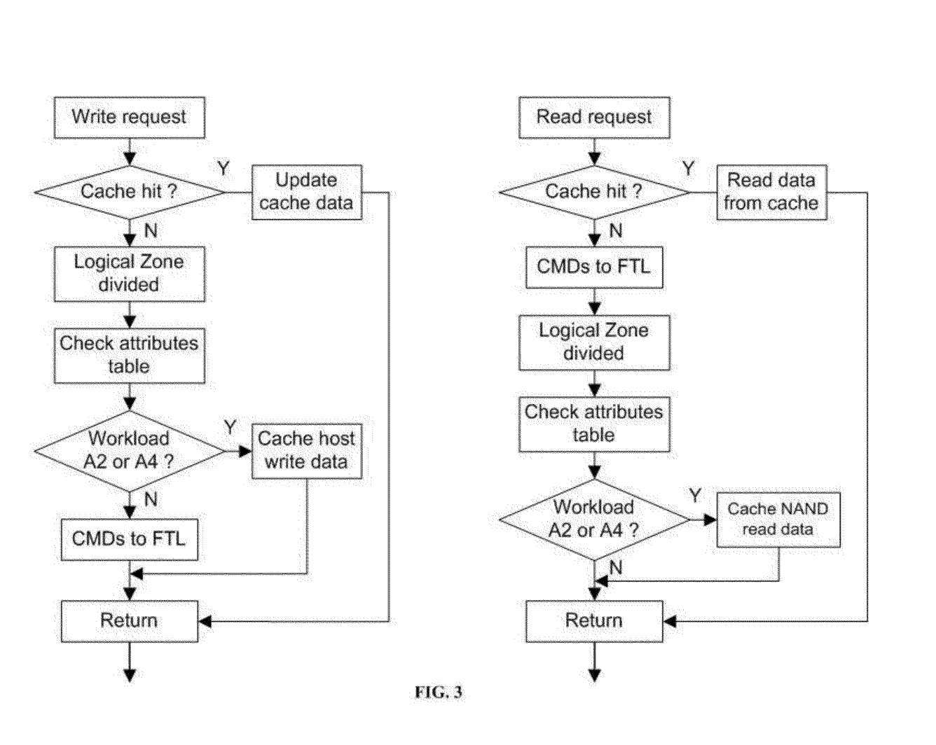

Referring to FIG. 3. In accordance to one embodiment of the presently claimed invention, the data caching strategy of a solid state drive is also adjustable based on data attributes. An attribute-aware data cache can inquire the data attribute table for both data write and read access/request. Particularly, for the workload types having hot data and small size data accesses (A2 and A4), the data should be cached (data written into cache for data write requests and data retrieved from cache for data read requests). The reason being that cold data will not be used imminently and it will only decrease the cache hit rate if cold data is cached. Also, large size data accesses would need larger cache size, thus lower cache hit rate as well.

The embodiments disclosed herein may be implemented using a general purpose or specialized computing device, computer processor, or electronic circuitry including but not limited to a digital signal processor (DSP), application specific integrated circuit (ASIC), a field programmable gate array (FPGA), and other programmable logic device configured or programmed according to the teachings of the present disclosure. Computer instructions or software codes running in the general purpose or specialized computing device, computer processor, or programmable logic device can readily be prepared by practitioners skilled in the software or electronic art based on the teachings of the present disclosure.

In some embodiments, the present invention includes a computer storage medium having computer instructions or software codes stored therein which can be used to program a computer or microprocessor to perform any of the processes of the present invention. The storage medium can include, but is not limited to, floppy disks, optical discs, Blu-ray Disc, DVD, CD-ROMs, and magneto-optical disks, ROMs, RAMs, flash memory devices, or any type of media or device suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for managing data of solid state storage according to one or more data attributes, comprising:
maintaining a data attribute table comprising one or more data attribute values of a workload comprising one or more data accesses and requests;
inquiring the data attribute table before selecting a mapping scheme and a log block utilization strategy for each of the data accesses and requests in the workload; and
selecting a mapping scheme and a log block utilization strategy for the workload based on the one or more data attribute values of the workload;
wherein the data attributes comprising access frequency, access sequence, and data access size;
wherein the access frequency indicating the workload being characterized as having either hot or cold data;
wherein the access sequence indicating the workload being characterized as having either sequential or random data accesses; and
wherein the data access size indicating the workload being characterized as having either large or small size data accesses.

2. The method of claim 1, wherein the data attributes further comprising request mode and request write ratio;
wherein the request mode indicating the workload being characterized as having either burst or smooth mode data requests; and
wherein the request write ratio indicating the workload being characterized as having either high or low write ratio.

3. The method of claim 1, wherein the solid state storage being divided into segments by one or more logical zones;
wherein the logical zones being defined by ranges of logical addresses;
wherein the workload of data accesses and requests comprises of data accesses and requests in one of the logical zones;
wherein the data attribute table further comprising one or more set of one or more data attribute values; each set of one or more data attribute values corresponding to the workload of each of the logical zones; and
wherein the selection of a mapping scheme and a log block utilization strategy being made for the workload of each of the logical zones.

4. The method of claim 1, wherein the data attribute values being computed based on statistics data accesses and requests in the workload over a time slice; and
wherein the data attribute values being re-computed at end of the time slice.

5. The method of claim 1, further comprising selecting a garbage collection strategy and a wear leveling strategy for the workload based on the one or more data attribute values of the workload.

6. The method of claim 3, further comprising selecting a garbage collection strategy and wear leveling strategy for the workload based on the one or more data attribute values of the workload of each of the logical zones.

7. The method of claim 1, wherein the inquiry to the data attribute table being performed only for data write accesses and requests but not for data read accesses and requests.

8. The method of claim 2, wherein the inquiry to the data attribute table being performed only for data write accesses and requests but not for data read accesses and requests.

9. The method of claim 1, wherein the data attribute values being equal to data attribute values of one of following access workload types:
A1.) hot data, sequential access, and large size data accesses;
A2.) hot data, sequential access, and small size data accesses;
A3.) hot data, random access, and large size data accesses;
A4.) hot data, random access, and small size data accesses;
A5.) cold data, sequential access, and large size data accesses;
A6.) cold data, sequential access, and small size data accesses;
A7.) cold data, random access, and large size data accesses; and
A8.) cold data, random access, and small size data accesses;
wherein for the data attribute values being equal to data attribute values of A1 or A2 access workload type, if a data write access in the workload having a logical address pointing to beginning of a logical block, a new spare block in a hot data zone is to be allocated for the data write access, otherwise a current spare block in the hot data zone is to be allocated for the data write access, unless the current spare block in the hot data zone is full, then a new spare block in a hot data zone is to be allocated;
wherein for the data attribute values being equal to data attribute values of A3 or A4 access workload type, the current spare block in the hot data zone is to be allocated for the data write access, unless the current spare block in the hot data zone is full, then a new spare block in a hot data zone is to be allocated;
wherein for the data attribute values being equal to data attribute values of A5 or A6 access workload type, if the data write access in the workload having a logical address pointing to beginning of a logical block, a new spare block in a cold data zone is to be allocated for the data write access, otherwise a current spare block in the cold data zone is to be allocated for the data write access, unless the current spare block in the cold data zone is full, then a new spare block in a cold data zone is to be allocated; and
wherein for the data attribute values being equal to data attribute values of A7 or A8 access workload type, the current spare block in the cold data zone is to be allocated for the data write access, unless the current spare block in the cold data zone is full, then a new spare block in a cold data zone is to be allocated.

10. The method of claim 9, further comprising selecting a wear leveling strategy for the workload based on the one or more data attribute values of the workload;
wherein the data attribute values being further equal to data attribute values of one of following request workload types:
R1.) burst mode and high write ratio;
R2.) burst mode and low write ratio;
R3.) smooth mode and high write ratio; and
R4.) smooth mode and low write ratio;
wherein for the data attribute values being equal to data attribute values of A5, A6, A7, or A8 access workload type and R1, R2, or R3 request workload type, if a new spare block in the cold data zone is to be allocated for the data write access, a new spare block of higher wear level in the cold data zone is to be allocated for the data write access; otherwise a new spare block of lower wear level in the cold data zone is to be allocated for the data write access.

11. The method of claim 9, further comprising selecting a garbage collection strategy for the workload based on the one or more data attribute values of the workload;
wherein the data attribute values being further equal to data attribute values of one of following request workload types:
R1.) burst mode and high write ratio;
R2.) burst mode and low write ratio;
R3.) smooth mode and high write ratio; and
R4.) smooth mode and low write ratio;
wherein if the data attribute values equal to data attribute values of A1, A2, A3, or A4 access workload type and R1 or R2 request workload type, then adjusting a garbage collection threshold;

12. The method of claim 9, further comprising checking whether a threshold for switching from page mapping scheme to block mapping scheme has been reached;
wherein if the threshold for switching from page mapping scheme to block mapping scheme has been reached and if the data attribute values equal to data attribute values of A5 or A6 access workload type, a merge using block mapping is commanded.

13. A method for managing data of solid state storage according to one or more data attributes, comprising:
maintaining a data attribute table comprising one or more data attribute values of a workload of data accesses and requests;
inquiring the data attribute table before selecting a data caching strategy for each of the data accesses and requests in the workload; and
selecting a data caching strategy for the workload based on the one or more data attribute values of the workload;
wherein the data attributes comprising access frequency, access sequence, and data access size;
wherein the access frequency indicating the workload being characterized as having either hot or cold data;
wherein the access sequence indicating the workload being characterized as having either sequential or random data accesses; and
wherein the data access size indicating the workload being characterized as having either large or small size data accesses.

14. The method of claim 13, wherein the solid state storage being divided into segments by one or more logical zones;
wherein the logical zones being defined by ranges of logical addresses;
wherein the workload of data accesses and requests comprises of data accesses and requests in one of the logical zones;
wherein the data attribute table further comprising one or more set of one or more data attribute values; each set of one or more data attribute values corresponding to the workload of each of the logical zones; and
wherein the selection of a data caching strategy being made for the workload of each of the logical zones.

15. The method of claim 13, wherein the data attribute values being computed based on statistics data accesses and requests in the workload over a time slice; and
wherein the data attribute values being re-computed at end of the time slice.

16. The method of claim 13, wherein the data attribute values being equal to data attribute values of one of following access workload types:
A1.) hot data, sequential access, and large size data accesses;
A2.) hot data, sequential access, and small size data accesses;
A3.) hot data, random access, and large size data accesses;
A4.) hot data, random access, and small size data accesses;
A5.) cold data, sequential access, and large size data accesses;
A6.) cold data, sequential access, and small size data accesses;
A7.) cold data, random access, and large size data accesses; and
A8.) cold data, random access, and small size data accesses; and
wherein if the data attribute values being equal to data attribute values of A2 or A4 access workload type, a data access or request in the workload being written into or read from a data cache; otherwise the data cache is to be bypassed.
